(19) United States
(12) Patent Application Publication
(10) Pub. No.: US 2025/0323558 A1
(43) Pub. Date: Oct. 16, 2025

(54) COOLING CONCEPT OF A DYNAMO-ELECTRIC MACHINE WITH INVERTER MODULES

(71) Applicant: Innomotics GmbH, 90441 Nürnberg (DE)

(72) Inventor: MARKUS HÖSLE, Erlangen (DE)

(73) Assignee: Innomotics GmbH, 90441 Nürnberg (DE)

(21) Appl. No.: 18/867,341

(22) PCT Filed: May 2, 2023
(86) PCT No.: PCT/EP2023/061451

§ 371 Date: Nov. 19, 2024

(30) Foreign Application Priority Data
May 27, 2022 (EP) 22175765.1

(51) Int. Cl. H02K 17/16; H02K 9/06; H02K 9/22

(52) U.S. Cl. CPC H02K 17/16; H02K 9/06; H02K 9/22

(57) ABSTRACT

A dynamo-electric rotary machine includes a stator having a hollow-cylindrical, magnetically conductive body, which has grooves in the region of an inner casing surface of the magnetically conductive body. Electrical conductors are received in the grooves and electrically contacted by a short-circuit ring on an end side of the magnetically conductive body of the stator. The electrical conductors are electrically contacted on another end side of the magnetically conductive body by a plurality of inverter modules for controlling the respective electrical conductor. A rotor is arranged spaced apart from the stator by an air gap and designed as a squirrel-cage rotor. The rotor has short-circuit rings on its end sides, wherein the conductors and/or the inverter modules and/or the rotor and/or the short-circuit ring of the stator can each be cooled, at least in a section thereof, by a gaseous medium, in particular air.

The Invention relates to a dynamo-electric machine with inverter modules and a method for cooling a dynamo-electric machine with inverter modules.

Winding systems of stators of dynamo-electric machines are constructed from winding wires or conductor bars, which are arranged in grooves of a magnetically conductive body of the stator.

However, if the winding system does not consist of a distributed three-phase winding using cables or wires, but rather consists of a large number of conductor bars, a high current intensity is required due to the comparatively low inductance. This high current only requires a relatively low voltage (<100V) due to the low ohmic resistance of the conductor bars. This low voltage makes it possible to arrange inverter modules with which the conductor bars are actuated at a relatively short distance from one another on the dynamo-electric machine.

These conductor bars are connected to one another on an end side of the magnetically conductive body of the stator via a short-circuit ring, and are fed on the other end side of the magnetically conductive body of the stator by assigned inverter modules in each case, as is known, for example, from DE 10 2005 032 965 A1.

These low voltages resulting from the winding concept enable a compact construction of the entire drive, i.e., the dynamo-electric machine and the power electronics.

Due to the compact construction and the comparatively high currents, comparatively high losses occur in the power electronics and in the conductor bars and their transitions.

To date, gas (in particular air) cooling systems or liquid (in particular water) cooling systems have been designed for drives in the higher power range (>0.5 MW) to meet the respective requirements of the dynamo-electric machine and separately also for the remotely installed converter.

Accordingly, the invention is based on the object of providing efficient and simple cooling for such a dynamic dynamo-electric machine, in particular for higher power classes (rated power >0.5 MW). Furthermore, an efficient method for cooling such a dynamo-electric machine is to be provided.

The stated object is achieved by a dynamo-electric rotary machine with
a stator having a hollow-cylindrical magnetically conductive body, in particular an axially layered lamination stack, which has grooves provided with electrical conductors in the region of its inner casing surface,
wherein these electrical conductors are electrically contacted on an end side of the magnetically conductive body of the stator by at least one short-circuit ring,
wherein these electrical conductors are electrically contacted on the other end side of the magnetically conductive body by a plurality of inverter modules for actuating the respective electrical conductors,
a rotor embodied as a squirrel-cage rotor, which is spaced apart from the stator by an air gap and has short-circuit rings on its end sides,
wherein the conductors and/or the inverter modules and/or the rotor and/or the short-circuit ring of the stator can in each case be cooled, at least in sections, by means of a gaseous medium, in particular air.

The electrical conductor arranged in a groove can be embodied as solid, as a hollow conductor bar, or as a conductor bar constructed from subconductors.

The conductor bar of each groove is constructed from subconductors extending in parallel. This makes it possible to avoid certain current displacement effects that occur with larger, especially solid, conductor cross sections. Furthermore, such a conductor construction makes it possible to actuate a predeterminable number of subconductors of a conductor bar via a separate inverter module. In other words, a conductor bar constructed from a predeterminable number of subconductors can be divided into subgroups, wherein each subgroup can be electrically assigned and contacted to one or more inverter modules.

In a further embodiment, the subconductors of a conductor bar are arranged transposed in the groove in order to further reduce current displacement effects.

Bar cooling of the hollow or solid conductor bars in the stator and/or rotor takes place by air flowing around or through the conductor bars, at least in sections. The conductor bars in the groove can also in each case be divided into parallel subconductors, which, when viewed over the axial length of a groove of the stator, extend straight (positionally accurate) or twisted (positionally alternating) within this groove.

The dynamo-electric rotary machine has a short-circuit ring of the stator and/or short-circuit rings of the rotor consisting of axially spaced-apart individual rings and/or ring segments joined together circumferentially. This simplifies manufacture and improves cooling of the short-circuit rings and/or the sections of a conductor located there.

To improve the cooling effect, the short-circuit rings of the rotor have fan elements that serve to generate a cooling air flow, in particular a substantially radial cooling air flow. This cooling air flow serves, inter alia, to cool the short-circuit ring of the stator and/or to cool the inverter modules of the dynamo-electric rotary machine.

These fan elements are arranged on the end sides of the short-circuit rings of the rotor and/or between the axially subdivided individual rings of a short-circuit ring of the rotor. Herein, axial spacing of Individual disks of the short-circuit ring of the stator and/or the inverter modules improves the cooling effect of these components.

Short-circuit rings can of course also be embodied in one piece.

The short-circuit ring could be formed by spaced-apart individual sheets or axially assembled individual sheets or a solid ring, which is preferably contacted with the conductor bars by the high-pressure process with which the hollow conductors are also fixed in the stator lamination stack.

In a further embodiment, the function of Integral fans can additionally or independently be taken over by the short-circuit ring(s) of the rotor in that blade-like or fan-like elements are formed on the short-circuit ring. In the case of a short-circuit ring of the rotor constructed from axially spaced-apart disks, blade-like or fan-like elements are arranged axially between the individual disks.

The dynamo-electric rotary machine has a magnetically conductive body, in particular axially layered lamination stacks, in the stator and rotor, wherein the conductors are positioned in grooves in the stator and rotor. The lamination stacks have substantially optionally axially-extending cooling channels and/or axially subdivided and axially spaced-apart partial lamination stacks of the stator and/or rotor. The magnetically conductive bodies of the stator and/or rotor, in particular their lamination stacks, can thus be cooled by axial and radial air flows.

In the case of a rotor lamination stack consisting of axially spaced-apart partial lamination stacks, the spacers arranged between the partial lamination stacks are preferably also embodied as blade-like or fan-like elements in order to convey air—if present—directly into the slots located radially thereabove between the partial lamination stacks of the stator upon rotation of the rotor.

Thus, an integral fan function can be generated by specific fans and fan blades positioned on the shaft in a rotationally fixed manner and/or by blade-like or fan-like elements on and/or in the short-circuit rings of the rotor and/or blade-like or fan-like elements between the partial lamination stacks of the rotor as soon as the rotor rotates.

Independent integral fans are connected to the shaft bearing the rotor in a rotationally fixed manner and are arranged radially inside the short-circuit rings of the stator and/or rotor.

The cooling of the drive or the dynamo-electric machine with the inverter modules can be open overall (heat exchange with the ambient air, for example via air slots in the machine housing) or embodied as a closed internal cooling circuit (primary circuit) within the machine housing with a secondary cooling facility for cooling the air flow of the primary circuit.

The respective air flows required (for open and closed circuits) or the conveyance of the cooling media can be carried out by integral fans and/or external fans.

The primary circuit refers to a gaseous cooling flow, in particular an air flow or air flow distribution, independent of single-sided or double-sided ventilation (Z or X ventilation) within the dynamo-electric machine, which flows onto and/or around and/or through components of the machine, such as, inter alia, inverter modules, short-circuit rings of the stator and/or rotor, magnetically conductive bodies of the stator and/or rotor, (for example lamination stacks or partial lamination stacks), conductors, at least housing sections, bearing shields and bearings, and is embodied as a closed circuit (internal cooling circuit) that has no flow contact with the outside.

The air flow of the primary circuit is generated by one or more integral fans and/or external fans, with positive or negative pressure, within the housing of the dynamo-electric machine.

The secondary circuit refers to a cooling flow, liquid cooling flow (for example based on water) or gaseous cooling flow (for example based on air) In the top-mounted cooler which is thermally coupled to the cooling flow of the primary circuit, i.e., can recool it, wherein the cooling flow or cooling flow distribution, in particular air in the secondary circuit, is generated by integral and/or external fans or corresponding pumps with positive or negative pressure.

The secondary circuit is preferably designed as open, i.e., it is operated with ambient air that is drawn in from the environment, heated by the medium in the primary circuit and then released back into the environment. This means that a dynamo-electric machine fitted with such a top-mounted cooler can be installed in almost any location. It may be necessary to provide filter mats or air filters for heavily contaminated air upstream of the secondary circuit.

Herein, each air flow of both the primary circuit and the secondary circuit can be divided, at least in sections, into parallel flow paths within its flow profile, in particular during the heat exchange between the primary circuit and the secondary circuit. This advantageously takes place by way of guide apparatuses in the dynamo-electric machine and/or in a secondary circuit embodied as a top-mounted cooler in order to optimize the cooling effect of the flow in the primary circuit and/or secondary circuit.

The internal cooling circuit or primary circuit of the dynamo-electric rotary machine can be designed as Z or X ventilation.

Single-sided ventilation (Z ventilation) of the internal cooling circuit refers to the ventilation of dynamo-electric machines in which an air flow (primary circuit) is fed into a winding overhang space on one side of the dynamo-electric machine and then passes through various parallel and/or serial flow channels—winding overhang, back of the lamination stack of the stator, radial cooling channels, air gap, etc.—to the other winding overhang space. From there, the heated air in the primary circuit passes through one or more fans—integral fans or external fans—into the top-mounted cooler for recooling.

The air in the primary circuit is thus guided through a winding overhang space into the housing of the dynamo-electric machine and from there through the winding overhang and the lamination stacks and/or the air gap into the other winding overhang space. From there, the now heated cooling air flow is recooled via the top-mounted cooler by means of the secondary circuit.

Double-sided ventilation (X ventilation) of the internal cooling circuit refers to the ventilation of the dynamo-electric machine in which an air flow (primary circuit) is fed into the winding overhang space on both sides of the dynamo-electric machine and then passes through various parallel and/or serial flow channels—inter alia, winding overhang, back of the lamination stack of the stator, radial cooling channels, air gap, etc.—into the top-mounted cooler, substantially centrally at the back of the stator lamination stack. The heated air in the primary circuit is conveyed by one or more fans—Integral fans or external fans—into the top-mounted cooler for recooling. Corresponding, in particular adjustable, aperture elements improve the flow profile in the primary circuit.

The secondary circuit, in particular the top-mounted cooler of the dynamo-electric rotary machine, is embodied as a tubular cooler or plate cooler with air or water as a cooling medium. Such closed cooling circuits are best realized with the following top-mounted coolers: (air-to-air-cooling units via tubular or plate coolers; or air-to-liquid cooling units via shell-type coolers or top-mounted coolers). Adjustable guide apparatuses, such as nozzle elements or aperture elements, guide and/or branch the air flow from the primary circuit and/or secondary circuit.

The inverter modules are cooled by a radial and/or axial air flow and by a specifically targeted flow in the case of particularly high heat loads.

In addition, the individual inverter modules can also be part of a separate liquid circuit.

Radial and/or also axial air flows flow onto, around or through the short-circuit rings of the stator and/or rotor in a targeted manner.

The number of electrical contact points, in particular between the inverter modules and their conductor bars, should be reduced and designed with low resistance in order also to avoid transition resistance, which also contributes to heating. The following methods are, for example, suitable for this: cold-spray, high-pressure joining, welding and soldering.

The axial layering of not only the short-circuit rings of the rotor and stator, but also of the magnetically conductive body of the stator and rotor is also advantageous for avoiding eddy currents.

The cooling of conductor bars (regardless of the embodiment, hollow, solid, subconductors, twisted), the short-circuit rings of the stator and rotor (one-piece or axially subdivided) and the inverter modules (axially subdivided) and/or the lamination stacks of the stator and rotor enable the drive to be cooled and thus also prevent—at least partially—heat from flowing from the machine into the inverter modules.

The invention and further advantageous embodiments of the invention are explained in more detail with reference to schematic depictions of exemplary embodiments, in which:

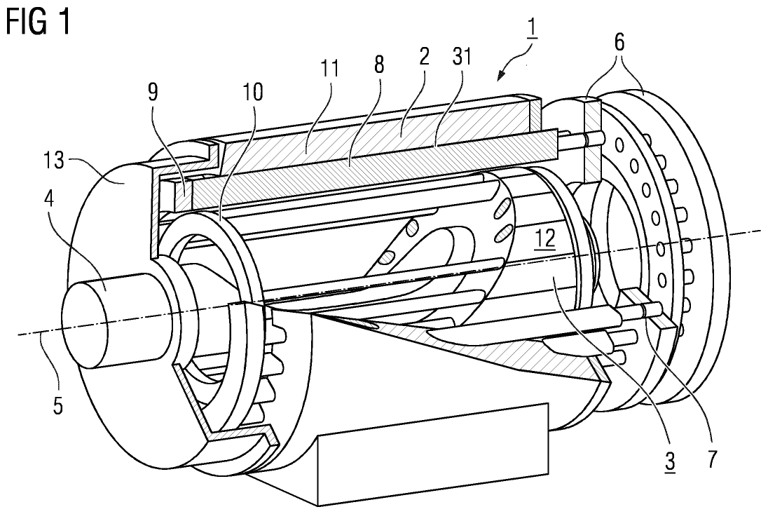

FIG. 1 shows a perspective depiction of a dynamo-electric machine,

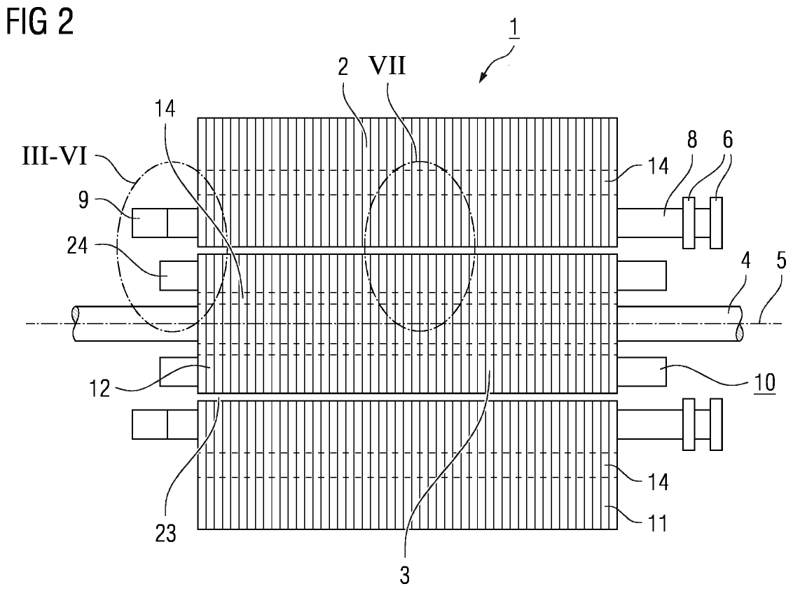

FIG. 2 shows a longitudinal section of a schematic depiction of a dynamo-electric machine,

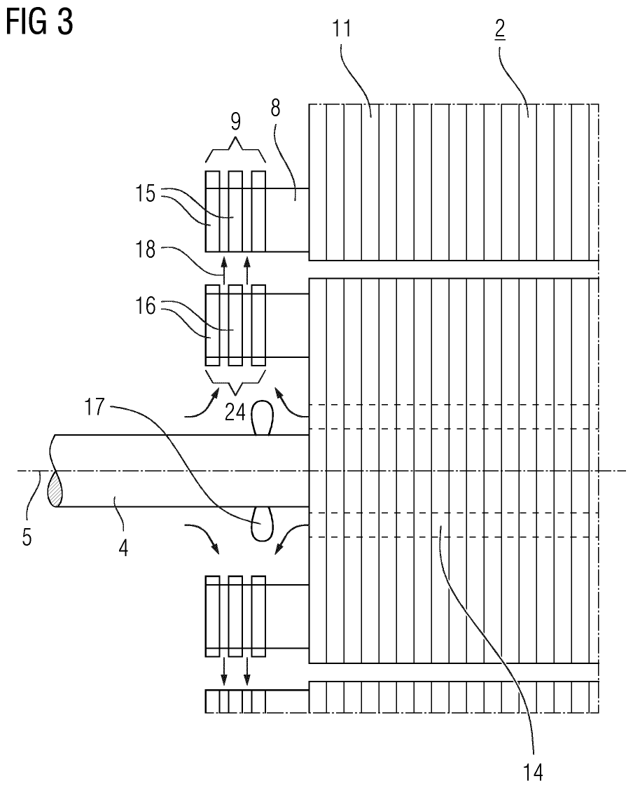

FIGS. 3 to 6 show longitudinal sections of an end side of the dynamo-electric machine,

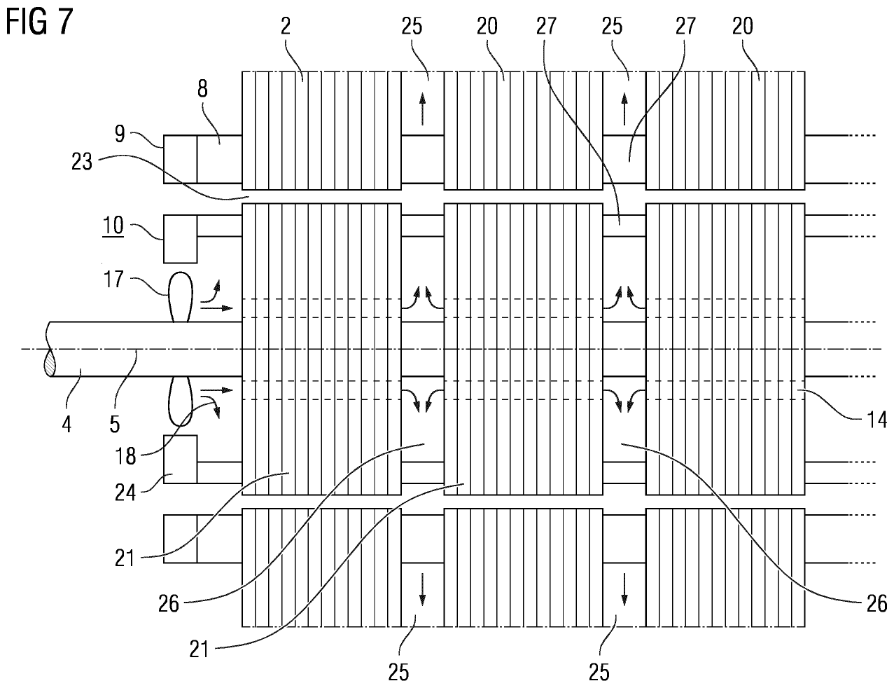

FIG. 7 shows a section of the lamination stacks of the stator and rotor,

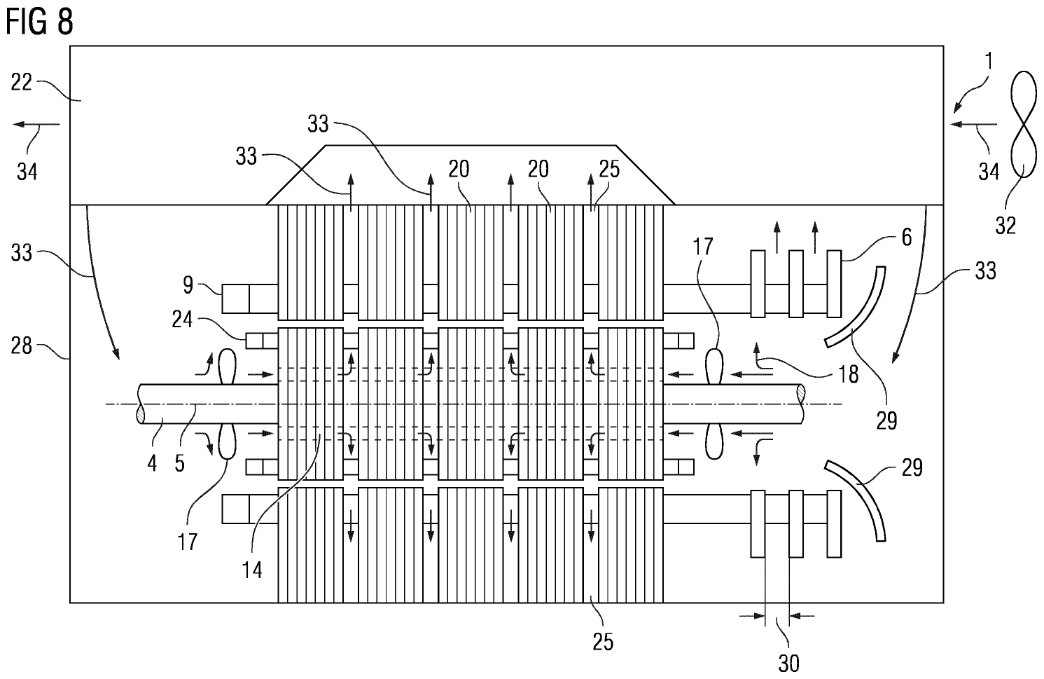

FIG. 8 shows a longitudinal section of a schematic depiction of a dynamo-electric machine with a top-mounted cooler,

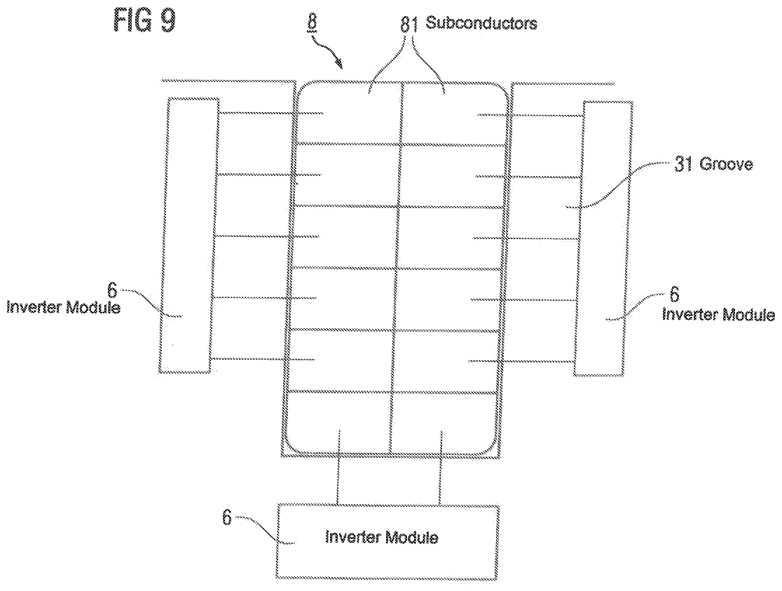

FIG. 9 shows a cross section of a groove.

It should be noted that terms such as “axial”, “radial”, “tangential” etc. relate to the axis 5 used in the respective figure or in the examples described in each case. In other words, the directions axial, radial and tangential always relate to an axis 5 of the rotor 3 and hence to the corresponding axis of symmetry of the stator 2. Herein, “axial” describes a direction parallel to the axis 5, “radial” describes a direction orthogonal to (toward or away from) the axis 5, and “tangential” is a direction in a circle around the axis 5 with a constant radial spacing from the axis 5 and at a constant axial position. The expression “in the circumferential direction” is equivalent to “tangential”.

In relation to an area, for example a cross-sectional area, the terms “axial”, “radial”, “tangential” etc. describe the orientation of the normal vector of the area, i.e., the vector that is perpendicular to the area in question.

The term “coaxial components”, for example coaxial components such as the rotor 3 and stator 2, should be understood to mean components with the same normal vectors, for which, therefore, the planes defined by the coaxial components are parallel to one another. Furthermore, the term is intended to imply that the center points of coaxial components lie on the same axis of rotation or symmetry. However, these center points may be located at different axial positions on this axis and the planes mentioned may have a spacing of >0 from one another. The term does not necessarily require coaxial components to have the same radius.

In the context of two components which are “complementary” to one another, the term “complementary” means that their external shapes are configured in such a way that one component may preferably be arranged completely in the component complementary to it, so that that the Inner surface of one component and the outer surface of the other component ideally touch one another, at least in sections, without gaps or over their entire area. Consequently, therefore, in the case of two mutually complementary objects, the outer shape of one object is defined by the outer shape of the other object. The term “complementary” could be replaced by the term “inverse”

For the sake of clarity, in cases in which components are present in multiple instances, frequently not all the components depicted are provided with reference characters.

The described embodiments of the cooling of such a drive or dynamo-electric machine 1 can be combined as desired. Similarly, individual features of the respective embodiments can also be combined with features of other embodiments without departing from the essence of the invention.

FIG. 1 shows a perspective depiction of the basic construction of a dynamo-electric machine 1 according to the invention. Inverter modules 6 are arranged on one end side of the magnetically conductive body of a stator 2. On the other end side of the magnetically conductive body of the stator 2, there is a short-circuit ring 9 of the stator 2 which electrically contacts and short circuits the individual conductor bars 8 of the stator 2 arranged in grooves 31. The magnetically conductive body of the stator 2 is constructed as an axially layered lamination stack 11. A rotor 3 is arranged radially spaced apart from the stator 2 by an air gap 23. This rotor 3 is connected in a rotationally fixed manner to a shaft 4 that can rotate about an axis 5. In this case, the rotor 3 is embodied with a squirrel cage 10. The magnetically conductive body of the rotor 3 is constructed as an axially layered lamination stack 12.

Provided that there is a plurality of inverter modules 6 for each conductor bar, the inverter modules 6 are likewise arranged axially layered one behind the other. Connector elements 7 which can carry the required current intensities (>1000 A) as operating current electrically connect, in particular with low resistance, the inverter modules 6 to their respective conductors, in particular conductor bars 8.

The conductor bars 8 can also be subdivided into subconductors 81 extending in parallel in the groove 31. This enables certain current displacement effects that occur with larger conductor cross sections to be avoided. Furthermore, such a conductor construction according to FIG. 9 makes it possible to actuate a predeterminable number of subconductors 81 of a conductor bar 8 via a separate inverter module 6.

In FIG. 9, a plurality of subconductors 6 are assigned to an inverter module 6, by way of example. Other assignments on the same radial plane or on one side of the groove 31 are likewise possible.

In other words, a conductor bar 8 constructed from a predeterminable number of subconductors 81 can be subdivided into a plurality of subgroups, wherein each subgroup can be electrically assigned and contacted to one or more inverter modules 10. Thus, it is also possible for only one subconductor 81 to be assigned to an inverter module 6. Due to the low voltage levels, the subconductors 81 for each groove 31 are provided with no insulation layer or a comparatively low insulation layer.

The shaft 4 is supported by bearings 35 and bearing shields 36 on a housing 28 and/or a cover 13 of the dynamo-electric machine 1.

FIG. 2 shows a longitudinal section of a schematic depiction of a dynamo-electric machine 1, wherein, inter alia, in addition to FIG. 1, the sections of this dynamo-electric machine 1 described in more detail below are depicted. This depiction shows that, in addition to the embodiment in FIG. 1, axially extending cooling channels 14 can also be provided in the lamination stack 11 of the stator 2, wherein axially extending cooling channels 14 can likewise also be provided in the lamination stack 12 of the rotor 3 radially inside the squirrel cage 10.

On one end side of the stator 2, the respective Inverter modules 6 are electrically contacted at the ends of the conductor bars 8 projecting axially from this end face.

FIG. 3 shows the other end side of the stator 2, wherein both the short-circuit ring 9 of the stator 2 and the short-circuit ring 24 of the rotor 3 is constructed from partial disks 15, 16. This makes it possible, for example, for an air flow 18 to flow radially between the partial disks 15, 16 of the short-circuit rings 9, 24 of the stator 2 and rotor 3 and thus, due to the larger surfaces of these short-circuit rings 9, 24, to efficiently cool both these short-circuit rings 9, 24 and the sections of the conductor bars 8 present there.

Herein, the air flow 18 can be generated by an external fan, not shown in detail, and/or a schematically depicted Integral fan 17 which is connected to the shaft 4 in a rotationally fixed manner. Herein, the radially conveyed air flow 18 is, inter alia, drawn in axially via the cooling channel 14, wherein the lamination stack 12 of the rotor 3 is also cooled thereby.

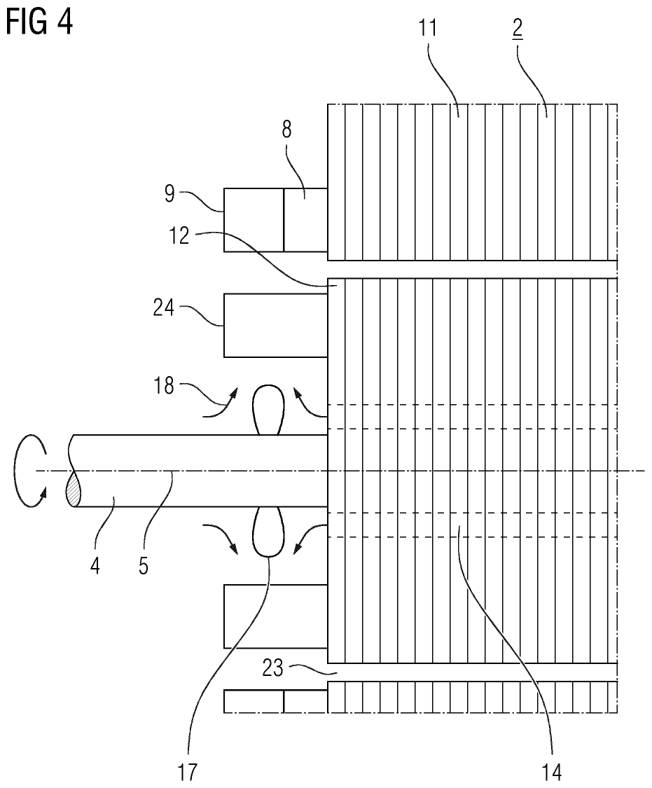

FIG. 4 likewise shows the other end side of the stator 2, wherein the short-circuit ring 9 of the stator 2 and short-circuit ring 24 of the rotor 3 are now embodied in one piece. An air flow 18, which is now provided by one or more integral fans 17 and/or one or more external fans, can thus flow around these one-piece short-circuit rings 9, 24 and the sections of the conductor bars 8.

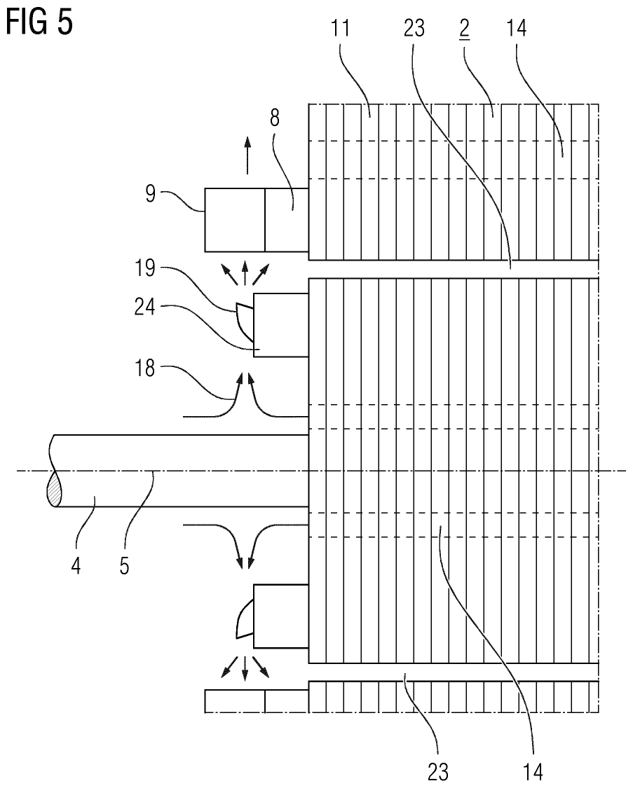

FIG. 5 likewise shows the other end side of the stator 2, wherein, in contrast to FIG. 4, the short-circuit ring 24 of the rotor 3 has on its end side fan elements 19, which generate a radial air flow in the direction of the short-circuit ring 9 of the stator 2. As in the embodiments in FIG. 3 and FIG. 4, the air is likewise, inter alia, drawn in from the cooling channel 14 of the rotor 3 and the wider environment.

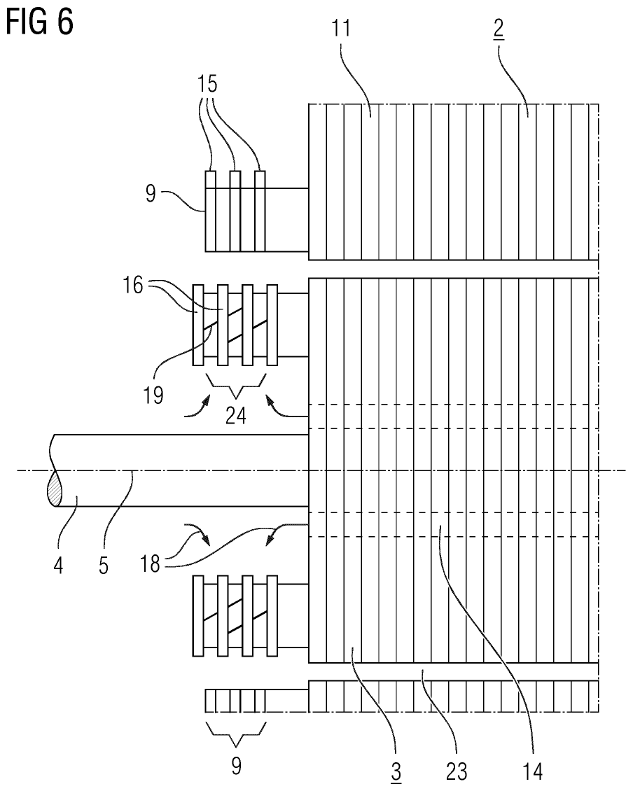

FIG. 6 likewise shows the other end side of the stator 2, wherein now the short-circuit ring 24 of the rotor 3 is constructed from partial disks 16 which are spaced apart from one another and thus have fan elements 19 between the partial disks 16 of the short-circuit ring 24 which likewise generate an integral fan function. As soon as the rotor 3 rotates, the Integral fan function is provided by corresponding integral fans or fan elements 19.

FIG. 7 shows a section of the dynamo-electric machine 1 with an end side of the stator 2, wherein the short-circuit rings 9, 24 are only depicted schematically. In this embodiment, the lamination stack 11, 12 of the stator 2 and rotor 3 is subdivided into axially layered partial lamination stacks 20, 21, wherein in particular spacers 27 of the rotor 3 are embodied as fan-like elements which generate an integral fan function when the rotor 3 rotates and thus, inter alia, convey cooling air from the channel 14 at least partially radially through the slot 26 of the rotor 3 and the slot 25 of the stator 2. Cooling air for the slots 25 of the stator 2 can also be provided via the air gap 23.

In order to achieve an improved cooling effect, the short-circuit rings 9, 24 of the stator 2 and rotor 3 can be arranged axially offset.

An axial spacing 30 between the inverter modules 6 enables efficient air cooling.

As previously implicitly described, the dynamo-electric rotary machines 1 according to the invention have an open cooling circuit. In a further embodiment according to FIG. 8, they can also have a closed internal cooling circuit or primary circuit 33, which is recooled.

In principle, cooling of this drive, i.e., the dynamo-electric machine 1, with the Inverter modules 6 can be embodied as open (heat exchange with the ambient air takes place, for example, via air slots in the machine housing by means of ambient air). Alternatively, cooling of this drive, i.e., the dynamo-electric machine 1, with the inverter modules 6 can also take place via a closed internal cooling circuit (primary circuit 33) within the housing 28, herein, the internal cooling circuit (primary circuit 33) can be recooled by a secondary cooling facility (secondary cooling circuit 34).

FIG. 8 shows a closed internal cooling circuit (primary circuit 33) within the housing 28 with a secondary cooling facility (top-mounted cooler 22) for cooling the air flow of the primary circuit 33.

Herein, the top-mounted cooler 22 can be embodied as a tubular cooler or plate cooler, wherein, in this case, there is primary-side X ventilation of the drive (in particular the dynamo-electric machine 1, with the inverter modules 6).

Regardless of single-sided or double-sided ventilation (Z or X ventilation) within the dynamo-electric machine 1, the primary circuit 33 refers to a gaseous cooling flow, in particular an air flow or air flow distribution, which flows onto and/or around and/or through the components of the dynamo-electric machine 1, such as inverter modules 6, short-circuit rings 9, 24 of the stator 2 and/or rotor 3, magnetically conductive bodies of the stator 2 and/or rotor 3, (for example lamination stacks 11, 12 or partial lamination stacks 20, 21), conductors 8, at least housing sections, bearing shields 36 and bearings 35, and is embodied as a closed circuit (internal cooling circuit or primary circuit 33) that has no flow contact with the outside. The air flow of the primary circuit 33 is generated by one or more integral fans 17 and/or external fans 32, with positive or negative pressure, within the housing 28 of the dynamo-electric machine 1.

The secondary circuit 34 refers to a cooling flow, liquid cooling flow (for example based on water) or gaseous cooling flow (for example based on air) in a top-mounted cooler 22 which is thermally coupled to the cooling flow of the primary circuit 33, i.e., can recool it, wherein the cooling flow or cooling flow distribution, in particular air in the secondary circuit 34, is generated by integral and/or external fans and/or corresponding pumps with positive or negative pressure.

The secondary circuit 34 is preferably embodied as open, i.e., it Is operated with ambient air which is drawn in from the environment, heated by the medium in the primary circuit 33 and then released back into the environment. This means that the dynamo-electric machine 1 fitted with such a top-mounted cooler 22 can be installed in almost any location without the risk of contamination of the interior of the drive (dynamo-electric machine 1, with the inverter modules 6). It is only necessary to clean the heat exchangers of the top-mounted cooler 22, such as tubes or plates to be cleaned. In addition, it may be necessary to provide filter mats or air filter for heavily contaminated air upstream of the inlet of the secondary circuit 34.

Herein, each air flow of both the primary circuit 33 and the secondary circuit 34 can be divided, at least in sections, into parallel flow paths within its flow profile, in particular during the heat exchange between the primary circuit 33 and the secondary circuit 34, which Increases the efficiency of the recooling.

This advantageously takes place by way of guide apparatuses in the dynamo-electric machine 1 and/or in the secondary circuit 34 embodied as a top-mounted cooler 22, in order to optimize the cooling effect of the flow in the primary circuit 33 and/or secondary circuit 34.

The Internal cooling circuit of the dynamo-electric machine 1 with the inverter modules 6—i.e., primary circuit 33—can be designed as Z or X ventilation.

Single-sided ventilation (Z ventilation) of the internal cooling circuit refers to the ventilation of the dynamo-electric machine 1 in which an air flow (primary circuit 33) is fed into a winding overhang space on one side of the dynamo-electric machine 1 and then passes through various parallel and/or serial flow channels—inter alia winding overhang, back of the lamination stack 11 of the stator 2, radial cooling channels, air gap 23, etc.—to the other winding overhang space. From there, the heated air in the primary circuit 33 is driven by one or more fans—integral fans or external fans—into the top-mounted cooler 22 for recooling.

The air in the primary circuit 33 is thus guided through a winding overhang space in the housing 28 of the dynamo-electric machine 1 and from there, inter alia, through the winding overhang and the lamination stacks 11, 12 and/or the air gap 23 into the other winding overhang space. From there, the cooling air, which may now be heated there, is recooled via the top-mounted cooler 22 by means of the secondary circuit 34.

Double-sided ventilation (X ventilation) of the Internal cooling circuit refers to the ventilation of the dynamo-electric machine 1 in which an air flow (primary circuit 33) is fed into the respective winding overhang space on both sides of the dynamo-electric machine 1 and then passes through various parallel and/or serial flow channels—inter alia winding overhang, back of the lamination stack 11 of the stator 2, radial cooling channels 25, 26, air gap 23, slots 25, 26 etc.—substantially centrally at the back of the stator lamination stack into the top-mounted cooler 22. The heated air in the primary circuit 33 is conveyed by one or more fans—integral fans or external fans—into the top-mounted cooler 22 for recooling. Corresponding, in particular adjustable, aperture elements, such as nozzle elements 29, improve the flow profile in the primary circuit 33 by allowing specific “hot-spots” (for example inverter modules 6) within the primary circuit 33 to be actuated in a targeted manner in terms of flow.

The secondary circuit 34—i.e., the top-mounted cooler 22—of the dynamo-electric rotary machine 1 can be provided as a tubular cooler or plate with air or water as a cooling medium. Such closed primary cooling circuits 33 are best implemented on the secondary side with the following top-mounted coolers 22 (air-to-air cooling units via tubular or plate coolers; or air-to-liquid cooling units via at least partially circumferential shell coolers or top-mounted coolers).

Herein, the top-mounted cooler 22 has channels or flow paths (not shown in detail) of the primary circuit 33 and secondary circuit 34. It also has corresponding openings with the housing 28 in order to realize the respective cooling principles.

Adjustable apparatuses such as nozzle elements 29 or aperture elements guide and/or branch the air flow of the primary circuit 33 within the housing 28 to the respective heat sources.

Guide apparatuses for the cooling air flow can also be provided in the secondary circuit 34.

A drive of this type, i.e., the dynamo-electric machine 1, with conductor bars 8 that can be separately actuated via Inverter modules 6 is especially suitable for industrial systems requiring greatly changing operating conditions

and control engineering reactions of the drive within a very short time. (Adaptation of magnetic axial or radial traction, reaction to rotor vibrations, speed adjustments, redundancy of the machine 1 in the event of failure of a conductor bar 8 or its inverter modules 6 etc.).

1.-14. (canceled)

15. A dynamo-electric rotary machine with a rated power >0.5 MW, the dynamo-electric rotary machine comprising:
a stator Including a hollow-cylindrical magnetically conductive body having grooves in a region of an inner casing surface of the hollow-cylindrical magnetically conductive body;
electrical conductors received in the grooves, with each of the electrical conductors being embodied as a conductor bar constructed from subconductors;
a short-circuit ring designed to electrically contact the electrical conductors on an end side of the magnetically conductive body of the stator;
a plurality of inverter modules designed to electrically contact the electrical conductors on another end side of the magnetically conductive body;
a rotor embodied as a squirrel-cage rotor in spaced-apart relation to the stator to define an air gap there between, and Including short-circuit rings on end sides of the rotor;
a closed internal cooling circuit or primary circuit having no flow contact with an outside and designed as Z or X ventilation;
a secondary circuit designed as a tubular cooler or plate cooler with air or water as a cooling medium; and
a heat exchanger arranged between the closed internal cooling circuit or primary circuit and the secondary circuit and designed as a top-mounted cooler to provide a heat exchange of the closed internal cooling circuit or primary circuit with the secondary circuit,
wherein a member selected from the group consisting of the electrical conductors, the inverter modules, the rotor, and the short-circuit ring of the stator has at least one section which is coolable by a gaseous medium.

16. The dynamo-electric rotary machine of claim 15, wherein the hollow-cylindrical magnetically conductive body is an axially layered lamination stack.

17. The dynamo-electric rotary machine of claim 15, wherein the gaseous medium is air.

18. The dynamo-electric rotary machine of claim 15, wherein at least one of the short-circuit ring of the stator and the short-circuit rings of the rotor is constructed from axially spaced-apart Individual rings and/or from ring segments.

19. The dynamo-electric rotary machine of claim 15, wherein the short-circuit rings of the rotor include fan elements to generate a cooling air flow.

20. The dynamo-electric rotary machine of claim 19, wherein the cooling air flow is a substantially radial cooling air flow.

21. The dynamo-electric rotary machine of claim 19, wherein the fan elements are arranged on the short-circuit rings of the rotor and/or between axially subdivided individual rings of a corresponding one of the short-circuit rings of the rotor.

22. The dynamo-electric rotary machine of claim 15, wherein the magnetically conductive body and the rotor are each designed as an axially layered lamination stack, wherein the axially layered lamination stack of at least one of the stator and the rotor is axially subdivided to form partial lamination stacks in spaced-apart relation from one another.

23. The dynamo-electric rotary machine of claim 15, further comprising at least one of an integral fan and one external fan for generating an air flow.

24. The dynamo-electric rotary machine of claim 23, further comprising a shaft for bearing the rotor, said integral fan being connected to the shaft in a rotationally fixed manner and arranged radially inside the short-circuit ring of the stator and/or the short-circuit rings of the rotor.

25. The dynamo-electric rotary machine of claim 23, wherein at least one of the integral fan and the external fan is arranged radially below the inverter modules.

26. A method for cooling a dynamo-electric rotary machine, the method comprising:
thermally coupling a primary cooling circuit and a secondary cooling circuit to provide heat exchange there between; and
cooling with a gaseous medium a member selected from the group consisting of electrical conductors received in grooves of a hollow-cylindrical magnetically conductive body of a stator of the dynamo-electric rotary machine, a short-circuit ring on an end side of the magnetically conductive body of the stator, inverter modules designed to electrically contact the electrical conductors on another end side of the magnetically conductive body, and a rotor in spaced-apart relation to the stator, by detecting a temperature of partial air flows of the primary cooling circuit and/or the secondary cooling circuit to Influence a course and/or the temperature of the partial air flows in both the primary cooling circuit and/or secondary cooling circuit

27. The method of claim 26, wherein the gaseous medium is air.

28. The method of claim 26, wherein the temperature and/or a rate of coolant flow in the primary cooling circuit and/or secondary cooling circuit is ascertained by a sensor and/or calculation.

29. The method of claim 26, further comprising actuating an external fan which is switchable on by a higher-level controller and/or an actuating element which influences an air flow.
